(19) United States
(12) Patent Application Publication
(10) Pub. No.: US 2015/0053273 A1
(43) Pub. Date: Feb. 26, 2015

(54) METHOD OF PUMPING FLUID, PULSE GENERATOR FOR USE IN THE METHOD, AND PUMP SYSTEM COMPRISING THE PULSE GENERATOR

(71) Applicant: SPP (BVI) LIMITED, Road Town, Tortola (VG)

(72) Inventors: Magomet Sagov, Hokksund (NO); Peter Grubyj, Hokksund (NO)

(21) Appl. No.: 14/390,016

(22) PCT Filed: Mar. 28, 2013
(86) PCT No.: PCT/EP2013/056686

§ 371 Date: Oct. 1, 2014

(30) Foreign Application Priority Data
Apr. 5, 2012 (EP) 12163347.3

(51) Int. Cl. F17D 1/14

(52) U.S. Cl. CPC F17D 1/14
USPC 137/14

(57) ABSTRACT

Method of pumping fluid through a tubing (200) by operating a pulse generator (100) at one end of the tubing (200), the pulse generator (100) reciprocates a displacement member (30) at a frequency of less than 3 Hz to generate pressure waves in the fluid which make a pulse converter (300) at the other end of the tubing (200) permit a flow of the fluid into the tubing (200). Further, there are disclosed a pulse generator (100) for use in the pumping method, and a pump system comprising the pulse generator (100). Said pulse generator (100) comprises: a connector (10) for connecting the pulse generator (100) with a tubing (200) through which fluid is to be pumped; a reciprocally operable displacement member (30, 32, 34) for generating pressure waves in the fluid to be pumped, said displacement member (30, 32, 34) being arranged in a cavity (20); a discharge port (42) for discharging pumped fluid; and a delivery passage (40) for delivering the pumped fluid from the connector (10) to the discharge port (42); and a return passage (50) for returning fluid delivered through the delivery passage (40) to the cavity (20). The displacement member (30, 32, 34) is arranged in the cavity (20) close to the connector (10) so as to face the connector (10).

### BACKGROUND OF THE INVENTION

The invention relates to a method of pumping fluid, a pulse generator for use in this method, and a pump system comprising the pulse generator.

US 2009/0000790 A1 discloses a short stroke piston pump comprising a motor connected to one end of a flexible drive rod, and a piston connected to another end of the flexible drive rod. The piston and the flexible drive rod are disposed in a tubing, and the piston is adapted to transport fluid up the tubing as the piston moves up and down in the tubing.

In order to dispense with the flexible drive rod, it is known to use a pulse generator for generating pressure waves at one end of a tubing containing a fluid, which travel to a pulse converter at the other end of the tubing so as to make the pulse converter permit a flow of the fluid into the tubing. The pulse converter may include a spring-loaded check valve which opens when the pressure wave is reflected at the other end of the tubing, and then closes again. Thus, each time the pulse converter is actuated by a pressure wave, an incremental fluid volume flows through the pulse converter into the tubing, is pumped towards the end of the tubing where the pulse generator is installed, and is discharged via a discharge port.

U.S. Pat. No. 2,355,618 A uses an acoustic generator having a vibrating piston for generating pressure waves and actuating a pulse converter. The frequency of vibration of the piston is adjusted to maintain a condition of substantial resonance in the fluid column within the tubing, and the time interval and the timing of the opening of a discharge valve are adjusted relative to the phase of the piston in its vibration to secure the best results. In order to prevent “gas lock”, it is proposed to curve the upper portion of the tubing and connect a discharge conduit to the extreme upper end of the curved portion, thus removing from the main fluid column, along with the discharged fluid, any gases which may have separated therein.

U.S. Pat. No. 4,460,320 A seeks to solve the problems with resonant timing which kept prior art pumps like the pump disclosed in U.S. Pat. No. 2,355,618 A from becoming commercially successful in general pumping applications. U.S. Pat. No. 4 460 320 A proposes the use of a sonic pressure wave generator which has a special piston for generating sonic pressure waves in a liquid by impacting the liquid in a ring-like configuration. In addition to generating the sonic pressure waves, the reciprocal movement of the piston alternately opens and closes a discharge port.

WO 2006/062413 A discloses a wave generator having a piston with internal check valves which is oscillated inside a tubing with a small amplitude in the range of 5 mm and a high frequency in the range of 100 Hz to cause the fluid at the downstream side of the piston to be supplied with a high power impulse from the piston. In another embodiment, pressure waves are generated by attaching an oscillating membrane to the circumference of the tubing.

### SUMMARY OF THE INVENTION

The problem to be solved by the present invention is to provide a method of pumping fluid using pressure waves which is practical for artificial lift of fluids from water and oil wells and for use in gas wells for gas well dewatering. A further object is to provide a pulse generator for use in this method, and a pump system comprising the pulse generator.

In a first aspect of the present invention, there is provided a method of pumping fluid through a tubing by operating a pulse generator, wherein the pulse generator has a displacement member that is provided at one end of the tubing and is reciprocated to generate pressure waves in the fluid which make a pulse converter provided at the other end of the tubing permit a flow of the fluid into the tubing. The displacement member is reciprocated at a frequency of less than 3 Hz. The frequency is preferably in a range of 2.5 to 0.5 Hz, more preferably in a range of 2.0 to 0.6 Hz for shallow wells with a depth of 50 to 500 m. The frequency is preferably less than 1.0 Hz for deeper wells. For example, the frequency can be 0.8 to 0.4 Hz for wells with a depth of about 750 m. It is expected that the preferred frequency is as low as 0.1 Hz for even deeper wells.

As far as the reason of the reduced frequency with the increased depth is concerned, a short explanation to this is that with the increased depth the wave length is increased and the wave propagation time required to reach the pulse converter is increased proportionally. In theory, the fluid is uncompressible and it should not be possible to create a compression wave in the fluid. In real life, however, the fluid contains a certain amount of air or gas which makes the fluid elastic enough for creation of a compression wave. The amount of air or gas in the fluid is individual for each well. Many parameters such as the tubing length, the amount of air in the fluid filled in the tubing before the pumping operation starts, the amount of air which enters into the tubing through the pulse converter when the pump is in operation, the amount of gas the well produces, fluid viscosity, and fluid temperature play a role.

A frequency as low as that defined above increases total pumping efficiency by avoiding frictional losses and losses caused by vibration, noise and the like. The frequency is so low that there will be no resonance.

Since frictional losses are low and there are no particular problems with resonance, vibration, noise and the like, the method according to the invention allows use of a tubing of smaller diameter than required by other known pumps used for artificial lift, for example a tubing with an inside diameter of not more than 2 inch (5.1 cm), 1.5 inch (3.8 cm), 1 inch (2.5 cm) or even less. This reduces the costs of drilling and total well infrastructure costs due to smaller diameter and cost of casing and tubing. However, the applicability of the invention is not limited to smaller tubing sizes. Larger tubing sizes can be used in cases when larger flow rates are required.

The tubing may branch off into a plurality of tubing strings, each having the pulse converter provided at the other end thereof and being installed in a respective well. In this case, it is possible to pump fluid with one and the same pulse generator from different wells so that total pumping efficiency is further increased. Such an arrangement is considered to be a specific feature of the invention which cannot be realized by any known pump in use today.

Further, each of a plurality of the pulse generators may be connected to a respective tubing. In this case, if the pulse generators are operated synchronously by one and the same driving means, total pumping efficiency can be further increased.

The method of the present invention may be advantageously used for pumping fluid from a water well or an oil well, or in a gas well for gas well dewatering.

When the method according to the invention is to be used for pumping fluid from a subterranean source such as the water well, the oil well, or the gas well to the surface level, a hole is drilled and a surface casing is inserted into the drilled hole until the subterranean source is reached, the tubing is inserted into the encased hole with the pulse converter being at the front end, and the surface located pulse generator is connected to the rear end of the tubing and operated. Since tubing size may be smaller, the drilling costs can be reduced. This makes the method according to the invention useful, but not limited to drilling wells with low flow rates and extending life time of existing wells with declining flow rates which cannot be economically exploited by prior art methods. Another field of use of the invention is pumping water from gas wells, i.e. gas well dewatering. The latter is particularly relevant since in most cases low flow rates of water are required to be pumped up and the use of a smaller tubing diameter can reduce the costs of the pumping operation since a tubing with smaller inside diameter can be used, for example 1 inch (2.5 cm, ¾ inch (1.9 cm) or ½ inch (1.3 cm).

If the method is used with a plurality of tube strings or tubings, it is possible to pump fluid from different wells.

In a second aspect of the present invention, there is provided a pulse generator for use in the method of the present invention. The pulse generator comprises a connector for connecting the pulse generator with a tubing through which fluid is to be pumped; a reciprocally operable displacement member for generating pressure waves in the fluid to be pumped, which is so arranged in a cavity close to the connector as to face the connector; a discharge port for discharging pumped fluid; a delivery passage for delivering the pumped fluid from the connector to the discharge port; and a return passage for returning fluid delivered through the delivery passage to the cavity.

In the pulse generator of the present invention, the displacement member of the pulse generator is arranged in the cavity close to the connector so as to face the connector. This minimizes losses upon generation of the pressure waves. Moreover, the pulse generator has the return passage that allows fluid to circulate from the cavity through the delivery passage back to the cavity. This compensates for the movement of the displacement member during the suction stroke, thereby reducing the power needed for operation and avoiding cavitation. In addition to reducing power consumption and avoiding cavitation, the use of produced fluid for circulation through the delivery passage reduces operation costs since there is no need for an additional fluid tank to supply the fluid particularly for this purpose.

Another aspect of the fluid circulation through the delivery and return passages is that it is possible to maintain a higher pressure (back pressure) in both passages by providing a pressure regulating valve (control valve). The pressure regulating valve is disposed in the delivery passage so as to control the flow rate and pressure of pumped fluid through the delivery passage. Controlling the flow rate and pressure through the delivery passage has a positive effect on the amplitude of the pressure wave generated by the displacement member and reduced power consumption. Further, the inflow of gas into the pulse converter is reduced.

The circulation of fluid from the cavity through the delivery and return passages back to the cavity can be ensured by providing each of the delivery passage and the displacement member with a check valve (first and second check valves). In this case, the displacement member may be either a piston or a disk-shaped member which is sealed via a membrane to a wall of the cavity. In an alternative configuration, the displacement member is a plunger and each of the delivery passage and the return passage is provided with a check valve (first and second check valves).

Another check valve (third check valve) may be provided at an outlet of the cavity so as to reduce the pressure drop during the suction stroke.

The pulse generator may further comprise a tank communicating with the discharge port, the delivery passage and the return passage, and an excess pressure valve for adjusting a back pressure in the tank. This arrangement is useful for adjusting the back pressure depending on the gas content of the fluid.

In a third aspect of the present invention, there is provided a pump system for pumping fluid, comprising a tubing through which fluid is to be pumped; a pulse converter provided at one end of the tubing; and the pulse generator of the present invention, which is connected to the other end of the tubing and has the reciprocally operable displacement member for generating pressure waves in the fluid which make the pulse converter at the one end of the tubing permit a flow of the fluid into the tubing.

In the pump system of the present invention, frictional losses are low and there are no particular problems with resonance, vibration, noise and the like. As a result, it is possible to use a tubing of smaller diameter than required by other known pumps used for artificial lift, for example a tubing with an inside diameter of not more than 2 inch (5.1 cm), 1.5 inch (3.8 cm), 1 inch (2.5 cm) or even less. As discussed above, this reduces the costs of drilling and total well infrastructure costs due to smaller diameter and cost of casing and tubing.

The tubing may branch off into a plurality of tubing strings, each having the pulse converter provided at the other end thereof. In this case, it is possible to pump fluid with one and the same pulse generator from different locations so that total pumping efficiency is further increased.

The pump system of the present invention may be advantageously used for pumping fluid from a water well or an oil well, or in a gas well for gas well dewatering. As discussed above, total pumping efficiency can be increased by reciprocating the displacement member of the pulse generator at a frequency of less than 3 Hz, with the frequency being the lower the deeper the well is.

### BRIEF DESCRIPTION OF THE DRAWINGS

The invention will be described in more detail with reference to preferred embodiments which are illustrated in the accompanying drawings.

FIG. 1 is a schematic view showing a first pump system for use in the present invention.

FIG. 2A is a plan view showing main parts of a pulse generator according to a first embodiment, and FIG. 2B is a cross-sectional view showing a displacement member of the pulse generator according to the first embodiment.

FIG. 3A is a plan view showing main parts of a pulse generator according to a modification of the first embodiment, and FIG. 3B is a cross-sectional view showing a displacement member of the pulse generator according to the modification of the first embodiment.

FIG. 4A is a plan view showing main parts of a pulse generator according to a second embodiment, and FIG. 4B is a cross-sectional view showing a displacement member of the pulse generator according to the second embodiment.

FIG. 5A is a plan view showing main parts of a pulse generator according to a third embodiment, and FIG. 5B is a cross-sectional view showing a displacement member of the pulse generator according to the third embodiment.

FIGS. 6A to 6C show experimental results for real time pressure at the pulse converter for different operating frequencies.

FIG. 7A is a schematic view showing a second pump system for use in the present invention, and FIG. 7B shows detail A of the second pump system.

FIG. 8A is a schematic view showing a third pump system for use in the present invention, and FIG. 8B shows detail A of the third pump system.

FIG. 9 is a schematic view showing a fourth pump system for use in the present invention.

### PREFERRED EMBODIMENTS

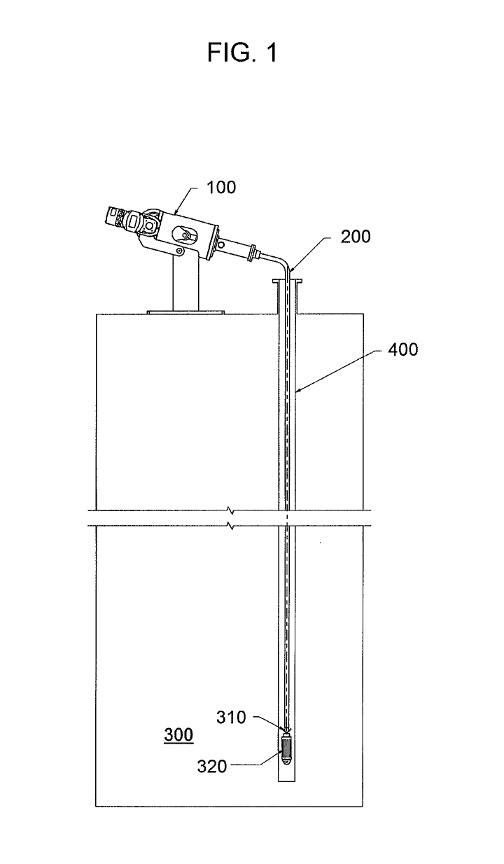

FIG. 1 is a schematic view showing a typical example of a pump system (first pump system) for use in the present invention. The first pump system comprises a tubing 200 inserted into an encased drill hole 400, a surface located pulse generator 100 at one end of the tubing 200, and a pulse converter 300 comprising a check valve 310 and a strainer 320 at the other end of the tubing 200. The bottom of the drill hole 400 is filled with fluid from a subterranean source including a liquid such as water, oil and the like, or a mixture of liquid and gas.

In order to pump the fluid from the bottom of the drill hole 400 through the tubing 200 to the surface level, the pulse generator 100 is operated such that a displacement member in the pulse generator reciprocates at a low frequency of less than 3 Hz. The frequency is preferably in a range of 2.5 to 0.5 Hz, more preferably in a range of 2.0 to 0.6 Hz for shallow wells with a depth of 50 to 500 m. The frequency is preferably less than 1.0 Hz for deeper wells. For example, the frequency can be 0.8 to 0.4 Hz for wells with a depth of about 750 m. It is expected that the preferred frequency is as low as about 0.1 Hz for even deeper wells.

The reciprocating movement of the displacement member generates pressure pulses in the fluid inside the tubing 200 which travel to the lower end of the tubing 200 where the check valve 310 is disposed. The pressure waves are reflected at the check valve 310 so that the check valve 310 is repeatedly opened for a short period of time and entry of an incremental fluid volume is permitted from the bottom of the drill hole 400 through the strainer 320 into the tubing 200. The additional fluid volume is extracted from the tubing 200 through a discharge port at the upper end of the tubing 200.

The inventors found that total pump efficiency is remarkably increased by setting the frequency of the reciprocating displacement member to less than 3 Hz. An increased pump efficiency means that the power needed to pump a certain amount of fluid is decreased.

The frequency range used in the pumping method of the invention is below the range of acoustic waves and thus prevents occurrence of resonance, vibration, noise and the like. Total pumping efficiency is increased by setting the frequency of the reciprocating displacement member to less than 3 Hz. The frequency should be the lower the deeper the well is in order to maximize efficiency of operation and flow rate.

The pumping method of the invention makes pumping heavy oils from ultra-shallow wells profitable which cannot be economically exploited by prior art methods. In general, “ultra”-shallow means that the well is not deeper than 600 m.

However, the use of the pumping method of the invention is not limited to pumping heavy oil from such ultra-shallow wells. In fact, it does not make much of a difference whether the fluid to be pumped is a liquid of high viscosity, a liquid of low viscosity, or a gas as long as the fluid is such that it enters the tubing 200 upon activation of the pulse converter 300 by the pressure waves. Depth is also no issue as long as the pressure of the fluid in the drill hole 400 is such that the pressure converter 300 stays closed until activation of the pulse converter 300 by the pressure waves.

Moreover, the use of the pumping method of the invention is not limited to pumping a fluid from a subterranean source through a vertical well. The fluid may be pumped through a directionally drilled well such as a slant well or horizontal well, or the fluid may be pumped through a pipeline with the tubing being the pipeline.

In the following, several embodiments of a pulse generator are described, which are specifically adapted to the pumping method of the invention and which may be used in place of the pulse generator 100 shown in FIG. 1.

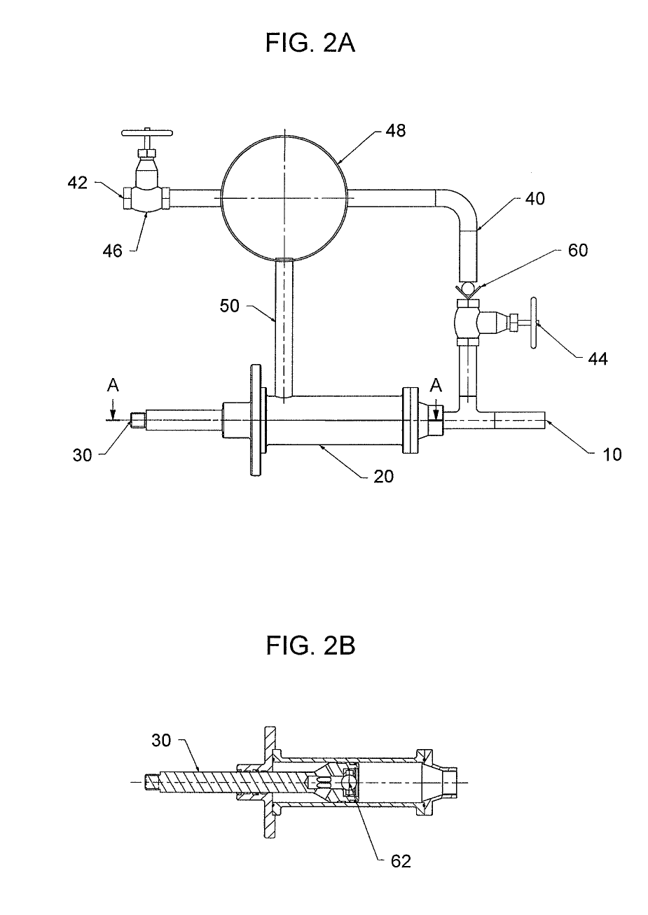

FIGS. 2A and 2B show a first embodiment of the pulse generator.

The pulse generator according to the first embodiment has a connector 10 for connection with, for example, a 1 inch (2.5 cm) tubing through which the fluid is to be pumped. Close to the connector 10, there is provided a cavity 20 which houses a reciprocally operable piston 30 as the displacement member for generating pressure waves in the fluid to be pumped. The piston 30 is so arranged in the cavity 20 as to face the connector 10. This minimizes losses upon generation of the pressure waves. The piston 30 has a piston shaft which is, for example, driven by a linear motor or a rotary electric motor and a cam mechanism therebetween (driving means).

At a position between the connector 10 and the cavity 20, a delivery passage 40 branches off which delivers pumped fluid to a tank 48. The delivery passage 40 is provided with a first check valve 60 to prevent backflow of the fluid. The fluid delivered to the tank 48 can be discharged via a discharge port 42. The discharge flow is controlled by a discharge valve (second control valve) 46.

The tank 48 communicates with a return passage 50 which returns fluid from the tank 48 to the rear of the piston 30 in the cavity 20. The piston 30 has an internal passage which connects the rear part of the cavity 20 with the front part close to the connector 10. A second check valve 62 is disposed in the internal passage of the piston 30 to permit fluid flow into the front part of the cavity 20 during the suction stroke of the piston 30 and to close the internal passage during the compression stroke.

The return passage 50 allows fluid to circulate from the cavity 20 through the delivery passage 40 to the tank 48 and back to the cavity 20. This compensates for the movement of the piston during the suction stroke, thereby reducing the power needed for driving the piston and avoiding cavitation. In addition to reducing power consumption and avoiding cavitation, the movement of the piston 30 is made independent from the flow of fluid pumped from the connector 10 or tubing into the delivery passage 40.

A pressure regulating valve (first control valve) 44 is disposed in the delivery passage 40 so as to control the pressure and flow rate of fluid through the delivery passage 40. Controlling the pressure and flow rate of fluid through the delivery passage 40 has an effect on maintaining back pressure in the fluid column which is particularly useful in order to reduce the inflow of gas into the pulse converter.

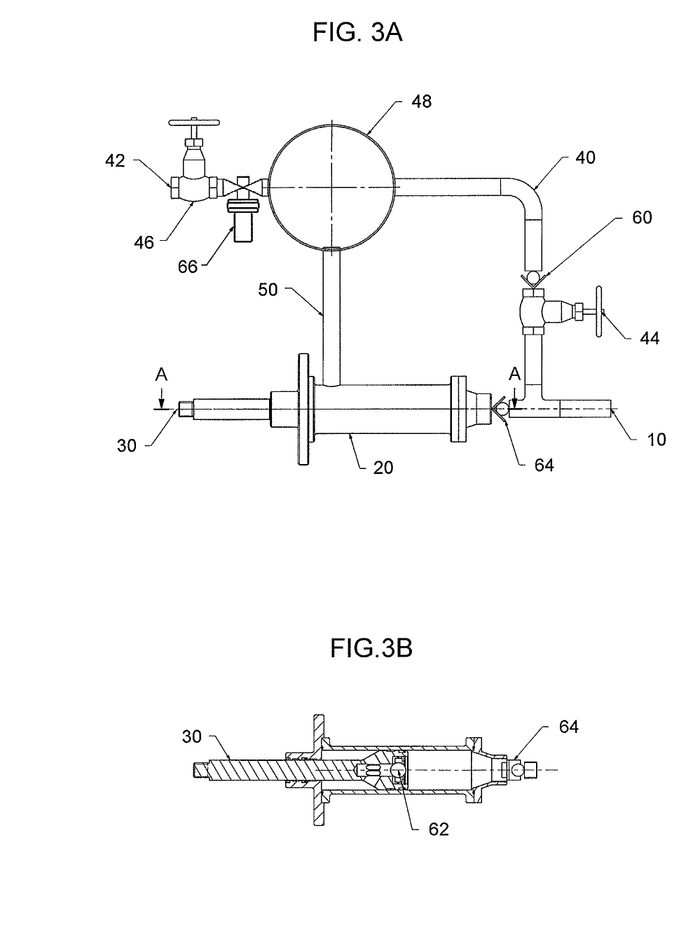

FIGS. 3A and 3B show a modification of the first embodiment.

The modified pulse generator shown in FIGS. 3A and 3B differs from the pulse generator of the first embodiment in that a third check valve 64 is provided at an outlet of the cavity 20 between the cavity 20 and the position where the delivery passage 40 branches off. The third check valve 64 reduces the pressure drop during the suction stroke. In addition, an excess pressure valve (third control valve) 66 is provided at the tank 48 in order to adjust the back pressure in the tank 48 depending on the gas content of the fluid in the drilled hole. As for the rest, the effects of the modified pulse generator are essentially the same as those of the first embodiment.

It is noted that the third check valve 64 and the excess pressure valve 66 do not need to be used in combination. The pulse generator may have the third check valve 64, but not the excess pressure valve 66, and vice versa.

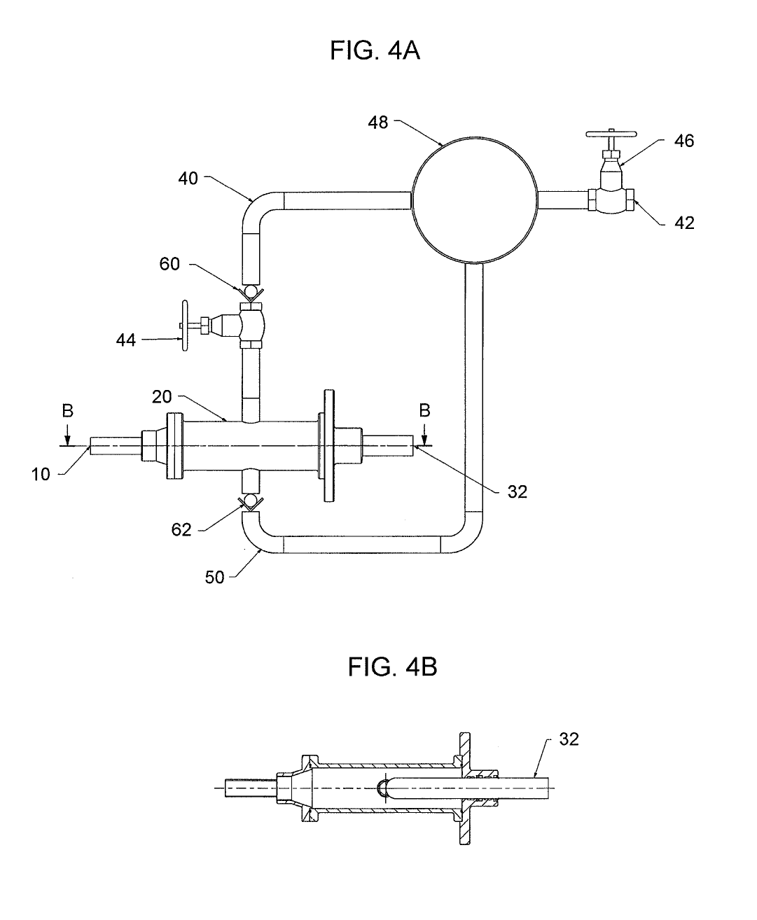

FIGS. 4A and 4B show a second embodiment of the pulse generator.

In the pulse generator according to the second embodiment, the connector 10 opens into a cavity 20 which houses a reciprocally operable plunger 32 as the displacement member for generating pressure waves. The plunger 32 is so arranged in the cavity 20 as to face the connector 10.

At a central position of the cavity 20, a delivery passage 40 branches off which delivers the pumped fluid to a tank 48. The delivery passage 40 is provided with a first check valve 60 to prevent backflow of the fluid, and a pressure regulating valve (first control valve) 44 for controlling the pressure and flow rate of fluid through the delivery passage 40. The fluid delivered to the tank 48 is discharged via a discharge port 42 with the discharge flow being controlled by a discharge valve (second control valve) 46.

The tank 48 communicates with a return passage 50 which returns fluid from the tank 48 via a second check valve 62 to a central position of the cavity 20 which is opposite to the inlet of the delivery passage 40. The return passage 50 allows fluid to circulate during the suction stroke of the plunger 32 from the cavity 20 through the delivery passage 40 to the tank 48 and back to the cavity 50.

A third check valve (not shown) may be provided at the outlet of the cavity 20 between the cavity 20 and the connector 10 so as to reduce the pressure drop during the suction stroke. The tank 48 may be provided with an excess pressure valve (not shown) in order to adjust the back pressure depending on the gas content of the fluid in the drilled hole.

The effects of the second embodiment are essentially the same as those of the first embodiment.

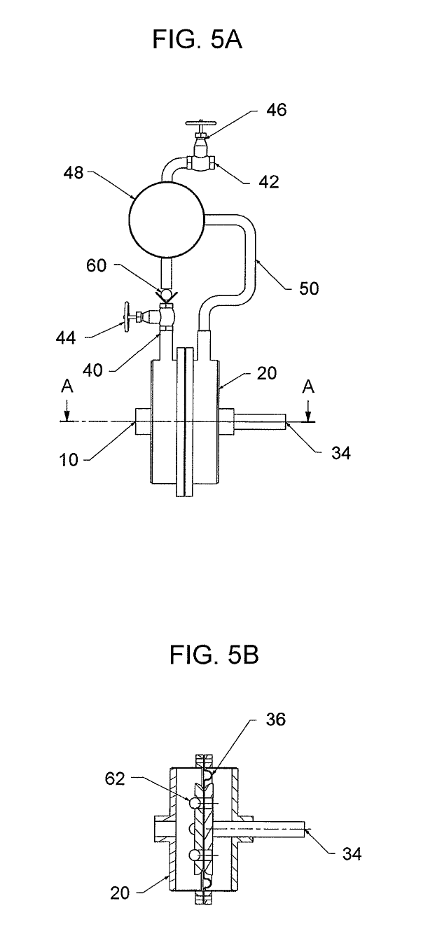

FIGS. 5A and 5B show a third embodiment of the pulse generator.

In the pulse generator according to the third embodiment, the connector 10 opens into a cavity 20 which houses a reciprocally operable disk-shaped member 34 as the displacement member for generating pressure waves. The disk-shaped member 34 is so arranged in the cavity 20 as to face the connector 10 and is sealed via a membrane 36 to a circumferential wall of the cavity 20.

At a front part of the cavity 20 close to the connector 10, a delivery passage 40 branches off which delivers the pumped fluid to a tank 48. The delivery passage 40 is provided with a first check valve 60 to prevent backflow of the fluid, and a pressure regulating valve (first control valve) 44 for controlling the pressure and flow rate of fluid through the delivery passage 40. The fluid delivered to the tank 48 is discharged via a discharge port 42 with the discharge flow being controlled by a discharge valve (second control valve) 46.

The tank 48 communicates with a return passage 50 which returns fluid from the tank 48 to a rear part of the cavity 20. The disk-shaped member 34 has internal passages which connect the rear part of the cavity 20 with the front part close to the connector 10. Second check valves 62 are respectively disposed in the internal passages of the disk-shaped member 34 to permit fluid flow into the front part of the cavity 20 during the suction stroke of the disk-shaped member 34 and to close the internal passages during the compression stroke. This allows circulation of fluid from the cavity 20 through the delivery passage 40 to the tank 48 and back to the cavity 20.

A third check valve (not shown) may be provided at the outlet of the cavity 20 between the cavity 20 and the connector 10 so as to reduce the pressure drop during the suction stroke. The tank 48 may be provided with an excess pressure valve (not shown) in order to adjust the back pressure depending on the gas content of the fluid in the drilled hole.

The effects of the third embodiment are essentially the same as those of the first and second embodiments.

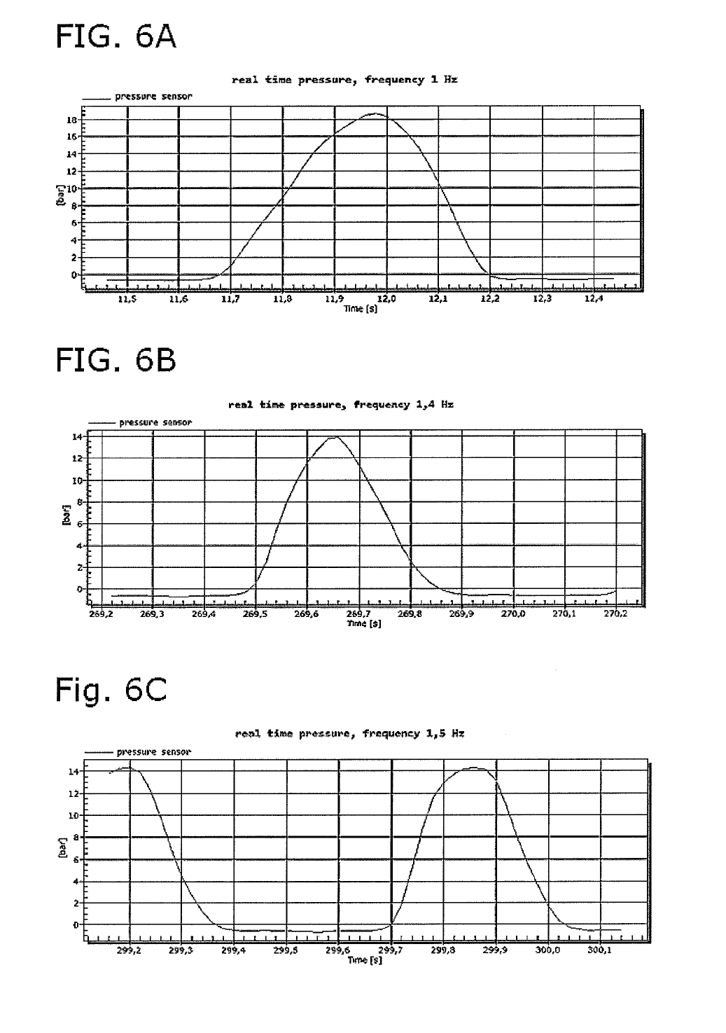

FIGS. 6A to 6C show experimental results obtained during operation of a pulse generator at an oil well similar to the one shown in FIGS. 2A and 2B In this test, the pulse generator was connected to 1 inch (2.5 cm) tubing and the pulse converter was installed at the lower end of the tubing at 1,200 feet (366 m) depth.

The pulse generator was operated at three different frequencies. FIGS. 6A to 6C respectively show the real time pressure detected at the pulse converter for frequencies of 1 Hz, 1.4 Hz, and 1.5 Hz. While the pressure waves have about the same amplitude and width for the frequencies of 1.4 Hz and 1.5 Hz, it is immediately apparent that the amplitude and width are greater for the frequency of 1 Hz. As consequence, the check valve of the pulse converter opens more and for a longer time and hence more fluid is pumped through the pulse converter into the tubing per piston stroke. As compared with the frequencies of 1.4 Hz and 1.5 Hz, less energy is needed at the frequency of 1 Hz for pumping the same amount of fluid so that total pumping efficiency is increased.

Other tests conducted on a 2500 feet (763 m) deep well showed that an operating frequency of 0.4 Hz has a good efficiency and flow rate.

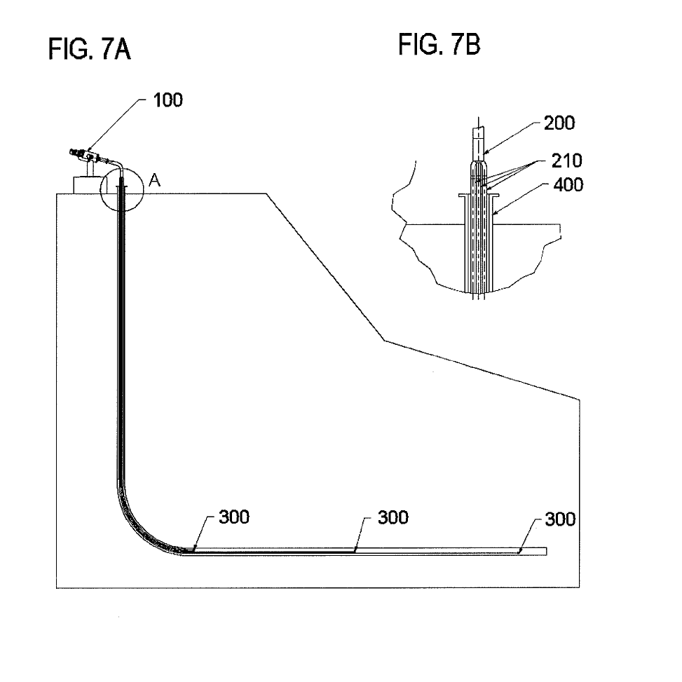

FIGS. 7A and 7B show a second example of a pump system (second pump system) for use in the present invention. In the second pump system, a plurality of three tubing strings 210 branch off from the end of the tubing 200 to which the pulse generator 100 is connected. Each tubing string 210 has a pulse converter 300 provided at the other end thereof. The drill hole 400 is a horizontal drill hole, and the tubing strings 210 have different lengths to pump fluid from different locations of the horizontal drill hole.

With the second pump system, it is possible to pump a greater amount of fluid over a larger length of the fluid reservoir with one and the same pulse generator 100 so that total pumping efficiency is further increased.

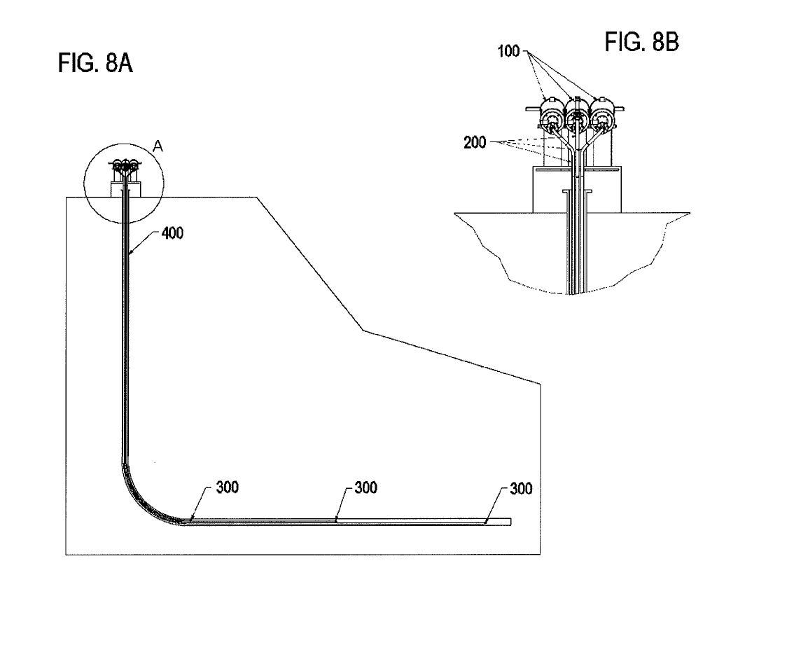

FIGS. 8A and 8B show a third example of a pump system (third pump system) for use in the present invention. In the third pump system, a plurality of three pulse generators 100 are connected to a respective one of three tubings 200. Each tubing 200 has a pulse converter 300 provided at the other end thereof. The drill hole 400 is a horizontal drill hole, and the tubings 200 have different lengths to pump fluid from different locations of the horizontal drill hole. The displacement members of the pulse generators 100 are driven by one and the same driving means so the displacement members reciprocate synchronously. The driving means includes, for example, the above-mentioned linear motor or rotary electric motor and cam mechanism.

With the third pump system, it is possible to pump a greater amount of fluid over a larger length of the fluid reservoir with one and the same driving means so that total pumping efficiency is further increased.

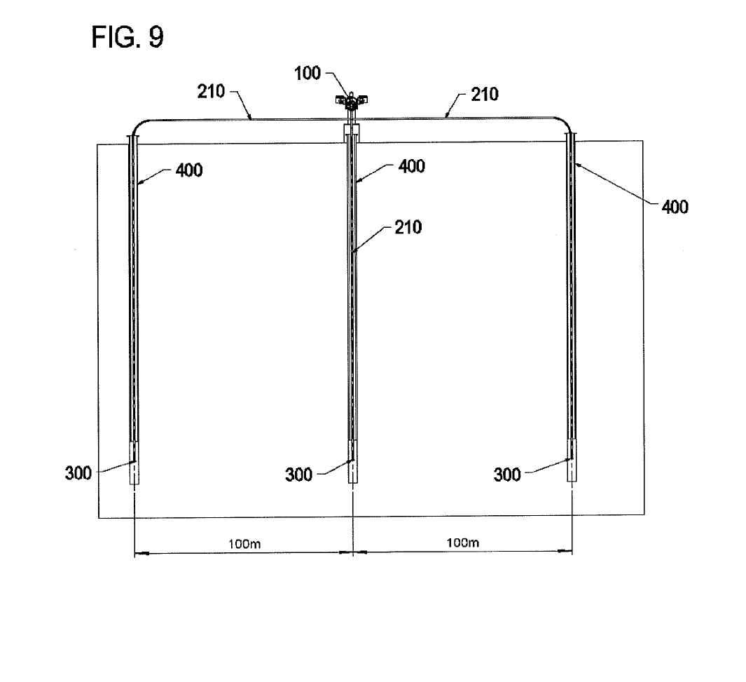

FIG. 9 show a fourth example of a pump system (fourth pump system) for use in the present invention. In the fourth pump system, a plurality of three tubing strings 210 branch off from the end of the tubing to which the pulse generator 100 is connected. Each tubing string 210 has a pulse converter 300 provided at the other end thereof. The tubings 200 are inserted in different vertical drill holes 400 which are separated by a distance of, for example, 100 m.

With the fourth pump system, it is possible to pump fluid from neighbouring wells with one and the same pulse generator 100. This increases total pumping efficiency and reduces equipment cost.

### LIST OF REFERENCE SIGNS

100 pulse generator
200 tubing
210 tubing string
300 pulse converter
310 check valve
320 strainer
400 drill hole
10 connector
20 cavity
30 piston
32 plunger
34 disk-shaped member
36 membrane
40 delivery passage
46 discharge port
44 pressure regulating valve (first control valve)
46 discharge valve (second control valve)
48 tank
50 return passage
60 first check valve
62 second check valve
64 third check valve
66 excess pressure valve (third control valve)

1-18. (canceled)

19. A method of operating a pump system for pumping fluid, said pump system comprising:
a tubing through which fluid is to be pumped;
a pulse generator connected to one end of the tubing, said pulse generator having a reciprocally operable displacement member for generating pressure waves in the fluid; and
a pulse converter provided at the other end of the tubing opposite to the one end of the tubing, wherein
said displacement member is reciprocated at a frequency of less than 3 Hz to generate the pressure waves which make the pulse converter at the other end of the tubing permit a flow of the fluid into the tubing.

20. A method of operating a pump system for pumping fluid, said pump system comprising:
a tubing through which fluid is to be pumped; and
a pulse generator connected to one end of the tubing, said pulse generator having a reciprocally operable displacement member for generating pressure waves in the fluid, wherein
the tubing branches off into a plurality of tubing strings, each having a pulse converter provided at a distal end thereof which is opposite to the one end of the tubing, and
the displacement member is reciprocated at a frequency of less than 3 Hz to generate the pressure waves which make the pulse converters at the distal ends of the tubing strings permit a flow of the fluid into the tubing strings.

21. The method according to claim 20, wherein each tubing string is installed in a respective well.

22. The method according to claim 20, wherein the tubing strings are inserted in a horizontal drill hole, and the tubing strings have different lengths to pump fluid from different locations of the horizontal drill hole.

23. A method of operating a pump system for pumping fluid, said pump system comprising:
a plurality of tubings through which fluid is to be pumped;
a pulse generator connected to one end of each of the plurality of tubings and having a reciprocally operable displacement member for generating pressure waves in the fluid; and
a pulse converter provided at the other end of each of the plurality of tubings, wherein
the pulse generators are operated synchronously with the displacement member of each pulse generator being reciprocated at a frequency of less than 3 Hz to generate the pressure waves which make the pulse converter at the other end of the tubing permit a flow of the fluid into the tubing.

24. The method according to claim 19, wherein the tubing has an inside diameter of not more than 2 inch (5.1 cm), preferably not more than 1.5 inch (3.8 cm), more preferably not more than 1 inch (2.5 cm).

25. The method according to claim 19, wherein said frequency is so low that there will be no resonance.

26. The method according to claim 19, wherein said displacement member is reciprocated at a frequency in a range of 2.5 Hz to 0.5 Hz.

27. The method according to claim 19, wherein said displacement member is reciprocated at a frequency of not more than 1.0 Hz.

28. The method according to claim 19, said method being used for pumping fluid from a water well or an oil well, or in a gas well for gas well dewatering.

29. The method according to claim 19, wherein the pulse generator comprises:
a connector connecting the pulse generator with the one end of the tubing;
a cavity in which the displacement member is arranged close to the connector so as to face the connector;
a discharge port for discharging pumped fluid;
a delivery passage for delivering the pumped fluid from the connector to the discharge port; and
a return passage for returning fluid delivered through the delivery passage to the cavity.

30. The method according to claim 29, wherein the pulse generator has a pressure regulating valve disposed in the delivery passage.

31. The method according to claim 29, wherein
the displacement member is a piston or a disk-shaped member sealed via a membrane to a wall of the cavity, and
each of the delivery passage and the displacement member is provided with a check valve.

32. The method according to claim 29, wherein
the displacement member is a plunger, and
each of the delivery passage and the return passage is provided with a check valve.

33. The method according to claim 29, wherein a check valve is provided at an outlet of the cavity.

34. The method according to claim 29, wherein the pulse generator further comprises:
a tank communicating with the discharge port, the delivery passage and the return passage; and
an excess pressure valve for adjusting a back pressure in the tank.
